(19) United States
(12) Patent Application Publication
(10) Pub. No.: US 2025/0287382 A1
(43) Pub. Date: Sep. 11, 2025

(54) UPLINK CHANNEL TRANSMISSION METHOD AND APPARATUS, AND TERMINAL AND NETWORK-SIDE DEVICE

(71) Applicant: VIVO MOBILE COMMUNICATION CO., LTD., Dongguan (CN)

(72) Inventor: Xiaohang CHEN, Dongguan (CN)

(21) Appl. No.: 19/217,123

(22) Filed: May 23, 2025

Related U.S. Application Data
(63) Continuation of application No. PCT/CN2023/133504, filed on Nov. 23, 2023.

(30) Foreign Application Priority Data
Nov. 30, 2022 (CN) 202211527170.6

(51) Int. Cl. H04W 72/21; H04L 5/14; H04W 72/0446

(52) U.S. Cl. CPC H04W 72/21; H04L 5/14; H04W 72/0446

(57) ABSTRACT

This application discloses an uplink channel transmission method and apparatus, a terminal, and a network-side device, and relates to the field of communication technologies. The uplink channel transmission method in embodiments of this application includes: receiving, by a terminal, at least one channel configuration from a network-side device, where the channel configuration is used to indicate at least one target channel, and each target channel corresponds to at least one spatial attribute; and sending, by the terminal, the target channel based on first information, where a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

### CROSS-REFERENCE TO RELATED APPLICATIONS

This application is a bypass continuation application of International Application No. PCT/CN2023/133504, filed on Nov. 23, 2023, which claims the benefit of and priority to Chinese Patent Application No. 202211527170.6, filed on Nov. 30, 2022, both of which are incorporated by reference in their entireties herein.

### TECHNICAL FIELD

This application relates to the field of communication technologies and, more specifically, relates to an uplink channel transmission method and apparatus, a terminal, and a network-side device.

### BACKGROUND

With advancements in communication technologies, full-duplex mode of operation has been introduced in communication systems. In full-duplex mode, separate antennas are typically required for transmission and reception, respectively. For example, distinct antenna arrays or panels are used for sending and receiving signals. To minimize mutual interference, isolation is implemented between antennas.

In a Time Division Duplex (TDD) mode, when a network device measures an uplink channel or a terminal measures a downlink channel, it is generally assumed that channel reciprocity exists between the uplink and downlink channel. This assumption helps reduce overhead associated with channel measurements.

### BRIEF SUMMARY

Embodiments of this application provide an uplink channel transmission method and apparatus, a terminal, and a network-side device.

According to a first aspect, an uplink channel transmission method is provided, including:
receiving, by a terminal, at least one channel configuration from a network-side device, where the channel configuration is used to indicate at least one target channel, and each target channel corresponds to at least one spatial attribute; and
sending, by the terminal, the target channel based on first information, where
a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

According to a second aspect, an uplink channel transmission method is provided, including:
sending, by a network-side device, at least one channel configuration to a terminal, where the channel configuration is used to indicate at least one target channel, and each target channel corresponds to at least one spatial attribute; and
receiving, by the network-side device, the target channel from the terminal based on first information, where
a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

According to a third aspect, an uplink channel transmission apparatus is provided, including:
a first receiving module, configured to receive at least one channel configuration from a network-side device, where the channel configuration is used to indicate at least one target channel, and each target channel corresponds to at least one spatial attribute; and
a first sending module, configured to send the target channel based on first information, where
a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

According to a fourth aspect, an uplink channel transmission apparatus is provided, including:
a second sending module, configured to send at least one channel configuration to a terminal, where the channel configuration is used to indicate at least one target channel, and each target channel corresponds to at least one spatial attribute; and
a second receiving module, configured to receive the target channel from the terminal based on first information, where
a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

According to a fifth aspect, a terminal is provided. The terminal includes a processor and a memory. The memory stores a program or instructions capable of running on the processor, and the program or the instructions are executed by the processor to implement the steps of the method according to the first aspect.

According to a sixth aspect, a terminal is provided, including a processor and a communication interface. The communication interface is configured to: receive at least one channel configuration from a network-side device, where the channel configuration is used to indicate at least one target channel, and each target channel corresponds to at least one spatial attribute; and send the target channel based on first information, where a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

According to a seventh aspect, a network-side device is provided. The network-side device includes a processor and a memory. The memory stores a program or instructions capable of running on the processor, and the program or the instructions are executed by the processor to implement the steps of the method according to the second aspect.

According to an eighth aspect, a network-side device is provided, including a processor and a communication interface. The communication interface is configured to: send at least one channel configuration to a terminal, where the channel configuration is used to indicate at least one target channel, and each target channel corresponds to at least one spatial attribute; and receive the target channel from the terminal based on first information, where a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

According to a ninth aspect, a communication system is provided, including a terminal and a network-side device. The terminal may be configured to perform the steps of the uplink channel transmission method according to the first aspect, and the network-side device may be configured to perform the steps of the uplink channel transmission method according to the second aspect.

According to a tenth aspect, a readable storage medium is provided. The readable storage medium stores a program or instructions, and the program or the instructions are executed by a processor to implement the steps of the method according to the first aspect or implement the steps of the method according to the second aspect.

According to an eleventh aspect, a chip is provided. The chip includes a processor and a communication interface, and the communication interface is coupled to the processor. The processor is configured to run a program or instructions to implement the steps of the method according to the first aspect or implement the steps of the method according to the second aspect.

According to a twelfth aspect, a computer program/program product is provided. The computer program/program product is stored in a storage medium. The computer program/program product is executed by at least one processor to implement the steps of the method according to the first aspect or implement the steps of the method according to the second aspect.

### BRIEF DESCRIPTION OF DRAWINGS

FIG. 1 is a schematic structural diagram of a network applicable to an embodiment of this application;

FIG. 2 is a flowchart of an uplink channel transmission method according to an embodiment of this application;

FIG. 3 is an example diagram of a transmission scenario of an uplink channel transmission method according to an embodiment of this application;

FIG. 4 is a flowchart of another uplink channel transmission method according to an embodiment of this application;

FIG. 5 is a structural diagram of an uplink channel transmission apparatus according to an embodiment of this application;

FIG. 6 is a structural diagram of another uplink channel transmission apparatus according to an embodiment of this application;

FIG. 7 is a structural diagram of a communication device according to an embodiment of this application;

FIG. 8 is a structural diagram of a terminal according to an embodiment of this application; and

FIG. 9 is a structural diagram of a network-side device according to an embodiment of this application.

### DETAILED DESCRIPTION

The following clearly describes technical solutions in embodiments of this application with reference to accompanying drawings in the embodiments of this application. Understandably, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, in the specification and claims, “and/or” represents at least one of connected objects, and the character “/” generally represents an “or” relationship between associated objects.

It should be noted that a technology described in the embodiments of this application is not limited to a (Long Term Evolution (LTE)/LTE-Advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” are often used interchangeably in the embodiments of this application. A technology described may be used for the systems and radio technologies described above, as well as other systems and radio technologies. The following describes a New Radio (NR) system for illustrative purposes, and NR terms are used in most of the following descriptions. However, these technologies are also applicable to applications such as a 6th Generation (6G) communication system other than NR system applications.

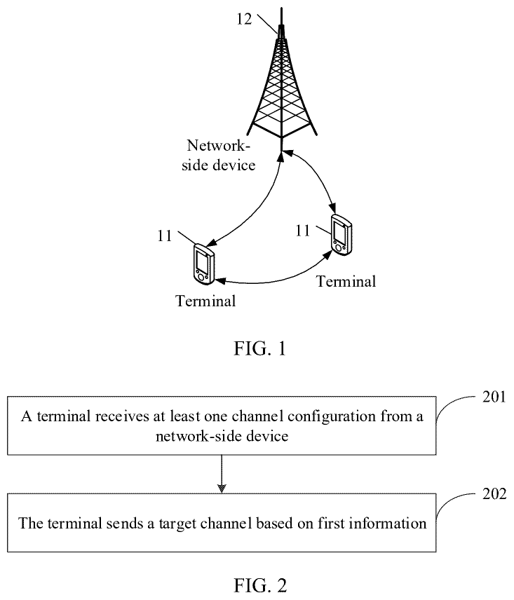

FIG. 1 is a block diagram of a wireless communication system applicable to an embodiment of this application. The wireless communication system includes a terminal 11 and a network-side device 12. The terminal 11 may be a mobile phone, a tablet personal computer, a laptop computer or referred to as a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home (a home device with a wireless communication function, such as a refrigerator, a television, a laundry machine, or a furniture), a gaming console, a personal computer (PC), a teller machine, a self-service machine, or another terminal-side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. Provided that same technical effects are achieved, the base station is not limited to a specific technical term. It should be noted that in the embodiments of this application, only a base station in an NR system is used as an example for description, and a specific type of the base station is not limited.

For ease of understanding, the following describes some content related to the embodiments of this application.

### I. For an Asymmetric Spectrum of TDD

Different frequency domain resources in some slots/on some symbols of TDD may be semi-statically configured or dynamically indicated as having both uplink sending and downlink reception.

### II. For a Half-Duplex Terminal

A terminal can perform only uplink sending or downlink reception at a same moment. In other words, the terminal is unable to receive and send a signal at the same moment.

### III. Slot Format

To implement flexible network deployment, a transmission direction of each symbol in a slot is configured by using a slot format in an NR system.

There are three definitions in terms of the transmission direction of the slot in NR: Downlink (DL), Uplink (UL), and flexible. When a network-side device configures a slot or a symbol as being DL or UL, a transmission direction at this moment is clear. When the network-side device configures a slot or a symbol as being flexible, a transmission direction at this moment is pending. The network-side device may modify a transmission direction of a flexible slot or symbol by using dynamic signaling such as a dynamic SFI (slot format indicator).

A slot may include downlink, uplink, and flexible Orthogonal frequency division multiplex (OFDM) symbols. The flexible symbol may be overridden as a downlink symbol or an uplink symbol.

Optionally, a slot format indicator (SFI) may indicate formats of one or more slots. The SFI is sent on a Group Common Physical Downlink Control Channel (GC-PDCCH).

The SFI can flexibly change the slot format as required to meet a service transmission requirement.

UE determines, based on an indication of the SFI, whether to monitor a PDCCH.

Optionally, the following cases are included in terms of a slot configuration:

1. The network-side device may semi-statically configure one or more cell-specific slot formats for the UE by using higher layer parameters UL-DL-configuration-common and UL-DL-configuration-common-Set2 (optional).

2. The network-side device may alternatively semi-statically configure one or more UE-specific slot formats for the UE by using a higher layer parameter UL-DL-configuration-dedicated.

3. The network-side device may override a flexible symbol or slot in a semi-static configuration by using the SFI carried on the GC-PDCCH.

### IV. Sounding Reference Signal (SRS)

In the 5th Generation (5G) mobile communication, based on different functions of the SRS, the SRS may be used for beam management, codebook-based transmission, non-codebook-based transmission, and antenna switching sending. User equipment (UE) may obtain a plurality of SRS resource sets by using higher layer signaling. Each SRS resource set configuration includes usage, a periodic characteristic, and the like of the SRS resource set.

The SRS and a Channel State Information Reference Signal (CSI-RS) each may be used as a reference of Quasi co-location (QCL), in other words, a network-side device may configure another physical channel and the SRS or the CSI-RS as being co-located. Both the SRS and the CSI-RS are channel sounding signals, but have the following differences in specific implementation details:

The SRS supports a maximum of four antenna ports, while the CSI-RS supports a maximum of 32 antenna ports.

The SRS has a low cubic metric, so that terminal power amplification efficiency can be increased.

Optionally, an SRS location is of a comb structure, and the SRS may occupy one, two, or four consecutive OFDM symbols, but is placed at locations of the last six symbols in 14 symbols of a slot. SRS signals of different terminals are multiplexed in frequency domain by using different comb offsets. For example, a comb-2 configuration can implement multiplexing for two users.

The network-side device may configure a periodic SRS, a semi-persistent SRS, or an aperiodic SRS for the terminal. Features such as an SRS periodicity are expressed per SRS resource set (resource set), in other words, attributes of all SRSs in one SRS resource set are the same. The SRS is used in a plurality of manners, and a behavior of specifically sending the SRS by the terminal is controlled by configuring some parameters. All parameters related to the semi-persistent SRS are configured by using higher layer signaling (for example, Radio Resource Control (RRC)). The terminal starts to send the SRS based on an RRC configuration parameter after a specified time upon activation of the SRS by using Medium Access Control Control Element (MAC CE) signaling, until the terminal receives a deactivation command from the network-side device. A parameter related to the aperiodic SRS is RRC configured, and a trigger command in DCI is used to notify the terminal to send the SRS once. 2 bits in the Downlink Control Information (DCI) indicate that a maximum of three SRS resource sets are to be configured for the terminal, and the remaining state indicates no activation. RRC configuration parameters include time domain parameters such as an SRS resource symbol location, a quantity of occupied symbols, frequency hopping, and a repetition parameter R.

Optionally, the following cases are included for determining a slot location.

For the periodic SRS and the semi-persistent SRS, a period and slot offset parameter is configured for an SRS resource in each SRS resource set to determine a period and a slot offset of the SRS resource. A slot location for sending the SRS may be determined by using the configured period and slot offset.

For the aperiodic SRS, one slot offset parameter is configured for each SRS resource set, in other words, SRS resources in the SRS resource set share one slot offset (and may occupy different symbols). A slot location for sending the aperiodic SRS resource set may be determined by receiving a receiving slot of DCI that triggers the SRS resource set, a subcarrier spacing between the DCI and the SRS, and the slot offset of the SRS resource set.

### V. Configured Grant (CG) Resource

For a requirement of a low-latency service or a periodic service, NR supports two configured UL grant uplink transmission manners: type1 and type2. A resource of the configured UL grant type1 may be semi-statically configured by using RRC signaling. After receiving the configuration, a user may perform transmission on the resource based on a service arrival status of the user and a configuration status, without dynamic scheduling by the DCI. A resource of the configured UL grant type2 may be semi-statically configured by using RRC signaling. After receiving the configuration, the user cannot directly use the resource. Only after a network-side device further activates the configuration by using DCI, the user can use the grant resource based on the activation DCI. The network-side device may further deactivate the configuration by using DCI, and a user receiving the deactivation DCI stops the grant resource.

### VI. Random Access Channel (RACH) Resource Configuration

In time domain, a network-side device indicates, by using a Physical Random Access Channel (PRACH) Configuration Index, a PRACH format to be used by UE and a location at which a preamble may be sent.

For a long preamble (formats 0 to 3), the UE mainly needs to know which subframe of which system frame can be used to send the preamble (a start symbol of the long preamble is usually 0, and is 7 in a few cases).

For a short preamble (formats A1, A2, A3, B1, B2, B3, B4, C0, and C2), the UE further needs to know which symbol of which slot can be used to send the preamble.

Currently, a terminal determines transmit power of uplink transmission based on an uplink power control configuration configured by a network. A parameter for uplink power control on uplink channel transmission, for example, target transmit power or a path loss estimation downlink reference signal, is also configured by the network-side device. In a full-duplex mode, after the network-side device performs specific isolation by using a transmit antenna and a receive antenna that are independent, uplink and downlink channel reciprocity cannot be ensured. In addition, for switching between the full-duplex mode and a half-duplex mode, a corresponding change may need to be made to an antenna configuration of the network-side device, causing degradation in uplink channel transmission performance. Therefore, an uplink channel transmission method of this application is provided.

With reference to the accompanying drawings, the following describes in detail the uplink channel transmission method provided in the embodiments of this application by using some embodiments and application scenarios thereof.

Referring to FIG. 2, an embodiment of this application provides an uplink channel transmission method. As shown in FIG. 2, the uplink channel transmission method includes the following steps:

Step 201: A terminal receives at least one channel configuration from a network-side device, where the channel configuration is used to indicate at least one target channel, and each target channel corresponds to at least one spatial attribute.

Step 202: The terminal sends the target channel based on first information.

A spatial attribute used to send the target channel is determined based on the first information, the target channel includes a configured grant Physical Uplink Shared Channel (PUSCH) or a configured grant Physical Uplink Control Channel (PUCCH), and the first information includes at least one of the following: a slot format, a slot type, and subband full duplex configuration information or subband full duplex indication information.

In this embodiment of this application, at least one first channel indicated by the channel configuration may include a first channel resource, a first channel transmission opportunity, a first channel resource set, or the like.

Optionally, a time domain type may include:
uplink (UL), used for an uplink time domain unit;
downlink (DL), used for a downlink time domain unit; and
full duplex/flexible duplex, which may be used for a DL time domain unit, a UL time domain unit, and a flexible time domain unit, where a specific type may include subband full duplex (SBFD).

Optionally, a time domain format or the time domain type may be indicated by a time division duplex uplink-downlink configuration (TDD-UL-DL-Configuration), a frequency division duplex uplink-downlink configuration (FDD-UL-DL-Configuration), a flexible duplex uplink-downlink configuration (XDD-UL-DL-Configuration), or the like; or may be configured by a higher layer of a network, for example, configured by using terminal-specific signaling or configured by using broadcast signaling.

The subband full duplex configuration information or the subband full duplex indication information may be used to indicate a full duplex frequency domain UL subband format, a full duplex frequency domain DL subband format, a guard band, a downlink (DL) Bandwidth Part (BWP), and an uplink bandwidth part (UL BWP).

Optionally, the corresponding spatial attribute may be determined based on the first information, so that the target channel is sent based on the spatial attribute corresponding to the first information. In this way, when the network-side device switches an antenna configuration, the target channel can be sent by using a spatial attribute suitable for a current antenna configuration.

It should be understood that when sending the target channel, the terminal may send the target channel based on an uplink transmission resource configured by the network-side device.

It should be noted that transmission in this embodiment of this application may be understood as sending and/or reception.

In this embodiment of this application, the terminal receives the at least one channel configuration from the network-side device, where the channel configuration is used to indicate the at least one target channel, and each target channel corresponds to at least one spatial attribute; and the terminal sends the target channel based on the first information, where the spatial attribute used to send the target channel is determined based on the first information, the target channel includes the configured grant physical uplink shared channel PUSCH or the configured grant physical uplink control channel PUCCH, and the first information includes at least one of the following: the slot format, the slot type, and the subband full duplex configuration information or the subband full duplex indication information. In this way, when the network-side device switches an antenna configuration, the target channel can be sent by using a spatial attribute suitable for a current antenna configuration. Therefore, uplink channel transmission performance is improved in this embodiment of this application.

Optionally, in some embodiments, that the terminal sends the target channel based on first information includes:
the terminal determines, based on an association relationship between the first information and the spatial attribute, a first spatial attribute corresponding to first information of a target time domain unit, where the target time domain unit is any time unit for sending the target channel; and
the terminal sends the target channel in the target time domain unit by using the first spatial attribute.

In this embodiment of this application, when sending the target channel, the terminal may first determine the first spatial attribute based on current second information, and then determine, based on a correspondence between the target channel and the spatial attribute, a target channel associated with the first spatial attribute, so as to send the determined target channel. In other words, when a target channel that currently needs to be sent is associated with a plurality of different spatial attributes, the target channel that currently needs to be sent may be sent by using the first spatial attribute.

Optionally, the time domain unit may be a slot, a sub-slot, N symbols, or the like. Specific duration may be set based on an actual requirement, and is not further limited herein.

Optionally, the association relationship between the first information and the spatial attribute may be indicated by the network-side device or specified in a protocol.

For example, in some embodiments, the association relationship may be determined according to a predefined rule. For example, it is determined that numbers (in ascending or descending order) of spatial attributes are associated with time units (in a specific time window or at a specific moment) that have a time domain format of UL/flexible and a time domain type of UL/SBFD X and in which the full duplex frequency domain UL subband format is effective.

For another example, in some embodiments, the network-side device may configure the association relationship, for example, configure at least one of the following:
a spatial attribute k is associated with a time unit (in a specific time window or at a specific moment) having a time domain type of UL; and
a spatial attribute n is associated with a time unit (or referred to as an SBFD time unit) (in a specific time window or at a specific moment) having a time domain type of X.

Optionally, in some embodiments, the time unit may be a time unit corresponding to a specific time window or a specific moment, and the specific time window and the specific moment may be configured by the network-side device or determined by the terminal based on other configuration information.

Optionally, in some embodiments, that the terminal sends the target channel in the target time domain unit by using the first spatial attribute includes at least one of the following: the terminal sends the target channel in the target time domain unit by using a sounding reference signal SRS resource set corresponding to the first spatial attribute or an SRS port associated with an SRS resource set corresponding to the first spatial attribute; and the terminal sends the target channel in the target time domain unit by using a spatial direction of SRS reception corresponding to the first spatial attribute or a spatial direction of channel state information reference signal reception corresponding to the first spatial attribute.

Optionally, in some embodiments, before the terminal sends the target channel based on the first information, the method further includes:
the terminal receives indication information from the network-side device, where the indication information is used to indicate the first information or second information.

The second information includes a spatial attribute associated with an uplink transmission resource, there is an association relationship between the spatial attribute and the first information, and the uplink transmission resource is used to transmit the target channel.

In this embodiment of this application, for transmission of a periodic or semi-persistent target channel, the terminal may receive the first information or the second information before sending the target channel.

Optionally, if the network-side device sends the first information to the terminal, the terminal determines a spatial attribute based on the indicated first information, and sends, in a time unit corresponding to the spatial attribute, a target channel corresponding to the spatial attribute. If the network-side device sends the second information to the terminal, the terminal sends, on each uplink transmission resource, a target channel corresponding to a spatial attribute corresponding to the uplink transmission resource.

Optionally, in some embodiments, the indication information is carried by using group common downlink control information DCI or scheduling DCI.

Optionally, in some embodiments, the indication information is used for at least one of the following:
transmission of the target channel in a target period;
transmission of the target channel in a next period of the target period;
transmission of the target channel in the target period and at least one period after the target period; and
transmission of the target channel in at least one period after the target period.

The target period is a period to which a moment at which the indication information is received belongs.

Optionally, that the terminal sends the target channel based on first information includes:
the terminal sends all repetitions of the target channel based on the first information.

In this embodiment of this application, for each repetition, a spatial attribute used for the current repetition is determined based on the first information.

For example, in some embodiments, the terminal transmits, by using a corresponding spatial attribute, each CG PUSCH or CG PUCCH repetition based on a time domain format, a time domain type, a subband full duplex configuration, or subband full duplex indication information of a time domain resource for the CG PUSCH or CG PUCCH repetition.

For another example, in some embodiments, the terminal determines a spatial attribute of each CG PUSCH or CG PUCCH repetition based on an SRS resource (or an SRS resource set) and a spatial attribute corresponding to a specific time domain format, a specific time domain type, a subband full duplex configuration, or subband full duplex indication information indicated by the network-side device, and transmits each CG PUSCH or CG PUCCH repetition by using the spatial attribute corresponding to each CG PUSCH or CG PUCCH repetition.

Optionally, in some embodiments, that the terminal sends the target channel based on first information includes:
the terminal sends a first repetition of the target channel based on the first information; and
the terminal sends an n^{th} repetition of the target channel based on a target transmission mode, where
n is an integer greater than 1, and the target transmission mode includes:
transmitting the target channel by using a second spatial attribute, where the second spatial attribute is determined based on the first repetition of the target channel.

Optionally, the second spatial attribute meets any one of the following:
the second spatial attribute is the same as a spatial attribute corresponding to the first repetition of the target channel; and
the second spatial attribute is determined based on a spatial attribute pattern associated with the first repetition of the target channel, where the spatial attribute pattern is used to indicate a spatial attribute corresponding to each of a plurality of repetitions of the target channel.

In this embodiment of this application, the network-side device may configure a plurality of spatial attribute patterns, and the terminal may perform the first repetition of the target channel based on a target spatial attribute pattern in the plurality of spatial attribute patterns, and then determine, based on the target spatial attribute pattern, a spatial attribute corresponding to each subsequent repetition. The target spatial attribute pattern may be indicated by the network-side device or determined by the terminal.

Optionally, the spatial attribute includes at least one of the following:
a number of an uplink transmission resource set;
a number of an uplink transmission resource;
a number of a spatial relationship;
a transmission configuration indication status or quasi co-location;
a quantity of ports or a port number;
a code division multiplexing CDM type or a CDM number; and
density of a resource element.

For better understanding of this application, the following provides detailed descriptions by using some instances.

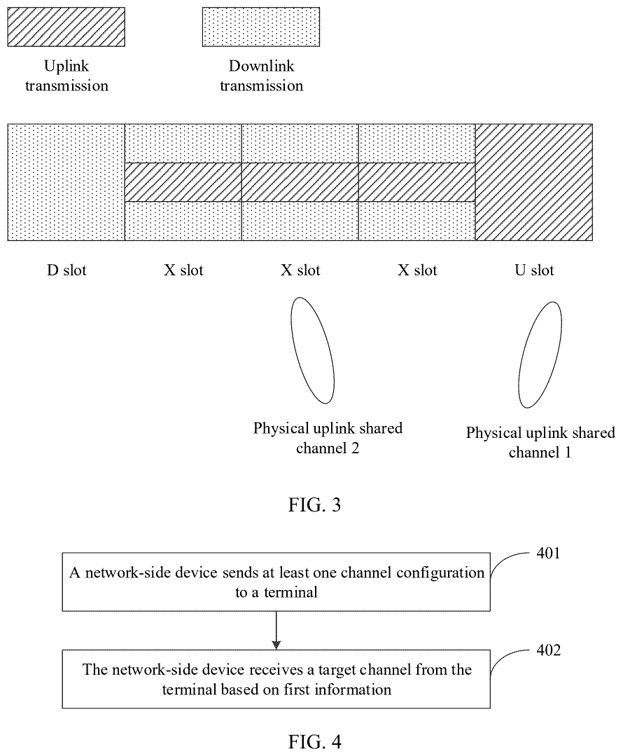

Optionally, as shown in FIG. 3, in some embodiments, an SRS is used to measure uplink channel state information, and it is assumed that a slot format is configured as DXXXU.

For a network-side device, a panel 1 (Panel 1) may be used for downlink transmission in a downlink slot (namely, a D slot), the panel 1 may be further used for downlink transmission in a flexible duplex slot (namely, an X slot), a panel 2 may be used for uplink reception in the X slot, and the panel 1 may be further used for uplink reception in an uplink slot (namely, a U slot). It is assumed that a CG PUSCH 1 carrying an SRS resource indicator 1 (SRS resource indicator, SRI 1) is used for the panel 1, a CG PUSCH 2 carrying an SRI 2 is used for the panel 1, and a transmission opportunity is configured for the CG PUSCH 1 in both the X slot and the U slot.

In this case, that a terminal performs CG PUSCH transmission based on a slot type by using a corresponding spatial characteristic includes the following behavior:
the CG PUSCH 1 based on the SRI 1 in the U slot; and
the CG PUSCH 2 based on the SRI 2 in the X slot.

Optionally, in some embodiments, an SRS is used to measure uplink channel state information, and it is assumed that a slot format is configured as DXXXU.

For a network-side device, a panel 1 (Panel 1) may be used for downlink transmission in a downlink slot (namely, a D slot), the panel 1 may be further used for downlink transmission in a flexible duplex slot (namely, an X slot), a panel 2 may be used for uplink reception in the X slot, and the panel 1 may be further used for uplink reception in an uplink slot (namely, a U slot). It is assumed that a CG PUSCH 1 carrying an SRS resource indicator 1 (SRS resource indicator, SRI 1) is used for the panel 1, a CG PUSCH 2 carrying an SRI 2 is used for the panel 1, and a transmission opportunity is configured for the CG PUSCH 1 in both the X slot and the U slot.

Optionally, in some embodiments, that a terminal performs CG PUSCH transmission based on a slot type by using a corresponding spatial characteristic includes the following behavior:
a repetition 1 of the CG PUSCH 2 based on the SRI 2 in the X slot;
a repetition 2 of the CG PUSCH 2 based on the SRI 2 in the X slot;
a repetition 3 of the CG PUSCH 2 based on the SRI 2 in the X slot;
a repetition 4 of the CG PUSCH 1 based on the SRI 1 in the U slot.

Optionally, in some embodiments, the terminal determines, based on a slot type of a first repetition, a spatial characteristic corresponding to each repetition, and in this case, performing CG PUSCH transmission includes the following behavior:
a repetition 1 of the CG PUSCH 2 based on the SRI 2 in the X slot;
a repetition 2 of the CG PUSCH 2 based on the SRI 2 in the X slot;
a repetition 3 of the CG PUSCH 2 based on the SRI 2 in the X slot;
a repetition 4 of the CG PUSCH 2 based on the SRI 2 in the U slot.

Optionally, in some embodiments, the terminal determines a spatial characteristic mapping pattern (pattern) based on a slot type of each repetition, to determine a spatial characteristic corresponding to each repetition and perform CG PUSCH transmission.

For example, the configured spatial characteristic mapping pattern may include at least one of the following: {SRI 1, SRI 2, SRI 1, SRI 2}, {SRI 1, SRI 1, SRI 2, SRI 2}, {SRI 1, SRI 1, SRI 1, SRI 2}, {SRI 1, SRI 1, SRI 1, SRI 1}, {SRI 2, SRI 1, SRI 2, SRI 2}, {SRI 2, SRI 2, SRI 1, SRI 1}, {SRI 2, SRI 2, SRI 2, SRI 1}, and {SRI 2, SRI 2, SRI 2, SRI 2}. Assuming that the spatial characteristic mapping pattern is determined to be {SRI 2, SRI 2, SRI 2, SRI 1} based on the slot type of each repetition, performing CG PUSCH transmission includes:
a repetition 1 of the CG PUSCH 2 based on the SRI 2 in the X slot;
a repetition 2 of the CG PUSCH 2 based on the SRI 2 in the X slot;
a repetition 3 of the CG PUSCH 2 based on the SRI 2 in the X slot;
a repetition 4 of the CG PUSCH 1 based on the SRI 1 in the U slot.

Referring to FIG. 4, an embodiment of this application further provides an uplink channel transmission method. As shown in FIG. 4, the uplink channel transmission method includes the following steps:

Step 401: A network-side device sends at least one channel configuration to a terminal, where the channel configuration is used to indicate at least one target channel, and each target channel corresponds to at least one spatial attribute.

Step 402: The network-side device receives the target channel from the terminal based on first information.

A spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

Optionally, that the network-side device receives the target channel from the terminal based on first information includes:
the network-side device determines, based on an association relationship between the first information and the spatial attribute, a first spatial attribute corresponding to first information of a target time domain unit, where the target time domain unit is any time unit for sending the target channel; and
the network-side device receives the target channel in the target time domain unit by using the first spatial attribute.

Optionally, the association relationship between the first information and the spatial attribute is specified in a protocol or configured by the network-side device.

Optionally, that the network-side device receives the target channel in the target time domain unit by using the first spatial attribute includes at least one of the following:
the network-side device receives the target channel in the target time domain unit by using a sounding reference signal SRS resource set corresponding to the first spatial attribute or an SRS port associated with an SRS resource set corresponding to the first spatial attribute; and
the network-side device receives the target channel in the target time domain unit by using a spatial direction of SRS reception corresponding to the first spatial attribute or a spatial direction of channel state information reference signal reception corresponding to the first spatial attribute.

Optionally, before the network-side device sends the at least one channel configuration to the terminal, the method further includes:
the network-side device sends indication information to the terminal, where the indication information is used to indicate the first information or second information.

The second information includes a spatial attribute associated with an uplink transmission resource, there is an association relationship between the spatial attribute and the first information, and the uplink transmission resource is used to transmit the target channel.

Optionally, the indication information is carried by using group common downlink control information DCI or scheduling DCI.

Optionally, the indication information is used for at least one of the following:
transmission of the target channel in a target period;
transmission of the target channel in a next period of the target period;
transmission of the target channel in the target period and at least one period after the target period; and
transmission of the target channel in at least one period after the target period.

The target period is a period to which a moment at which the indication information is received belongs.

Optionally, that the network-side device receives the target channel from the terminal based on first information includes:
the network-side device receives all repetitions of the target channel from the terminal based on the first information.

Optionally, that the network-side device receives the target channel from the terminal based on first information includes:
the network-side device receives a first repetition of the target channel from the terminal based on the first information; and
the terminal receives an n^{th} repetition of the target channel from the terminal based on a target transmission mode, where
n is an integer greater than 1, and the target transmission mode includes:
transmitting the target channel by using a second spatial attribute, where the second spatial attribute is determined based on the first repetition of the target channel.

Optionally, the second spatial attribute meets any one of the following:
the second spatial attribute is the same as a spatial attribute corresponding to the first repetition of the target channel; and
the second spatial attribute is determined based on a spatial attribute pattern associated with the first repetition of the target channel, where the spatial attribute pattern is used to indicate a spatial attribute corresponding to each of a plurality of repetitions of the target channel.

Optionally, the spatial attribute includes at least one of the following:
a number of an uplink transmission resource set;
a number of an uplink transmission resource;
a number of a spatial relationship;
a transmission configuration indication status or quasi co-location;
a quantity of ports or a port number;
a code division multiplexing CDM type or a CDM number; and
density of a resource element.

The uplink channel transmission method provided in the embodiments of this application may be performed by an uplink channel transmission apparatus. In the embodiments of this application, the uplink channel transmission apparatus provided in the embodiments of this application is described by using an example in which the uplink channel transmission apparatus performs the uplink channel transmission method.

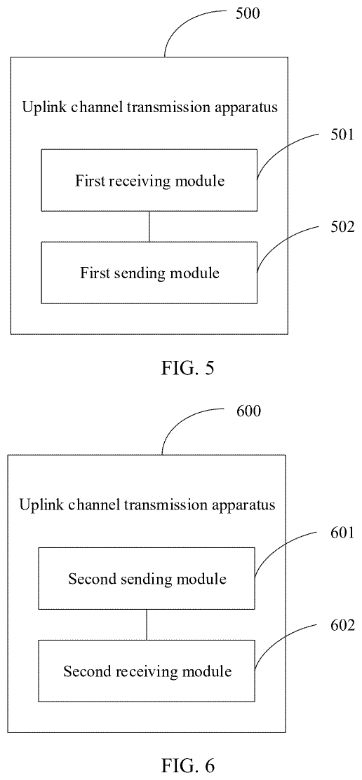

Referring to FIG. 5, an embodiment of this application further provides an uplink channel transmission apparatus. As shown in FIG. 5, the uplink channel transmission apparatus 500 includes:
a first receiving module 501, configured to receive at least one channel configuration from a network-side device, where the channel configuration is used to indicate at least one target channel, and each target channel corresponds to at least one spatial attribute; and
a first sending module 502, configured to send the target channel based on first information.

A spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

Optionally, the first sending module 502 includes:
a first determining unit, configured to determine, based on an association relationship between the first information and the spatial attribute, a first spatial attribute corresponding to first information of a target time domain unit, where the target time domain unit is any time unit for sending the target channel; and
a sending unit, configured to send the target channel in the target time domain unit by using the first spatial attribute.

Optionally, the association relationship between the first information and the spatial attribute is specified in a protocol or configured by the network-side device.

Optionally, the sending unit is specifically configured to perform at least one of the following:
sending the target channel in the target time domain unit by using a sounding reference signal SRS resource set corresponding to the first spatial attribute or an SRS port associated with an SRS resource set corresponding to the first spatial attribute; and
sending the target channel in the target time domain unit by using a spatial direction of SRS reception corresponding to the first spatial attribute or a spatial direction of channel state information reference signal reception corresponding to the first spatial attribute.

Optionally, the first receiving module 501 is further configured to receive indication information from the network-side device, where the indication information is used to indicate the first information or second information.

The second information includes a spatial attribute associated with an uplink transmission resource, there is an association relationship between the spatial attribute and the first information, and the uplink transmission resource is used to transmit the target channel.

Optionally, the indication information is carried by using group common downlink control information DCI or scheduling DCI.

Optionally, the indication information is used for at least one of the following: transmission of the target channel in a target period;
transmission of the target channel in a next period of the target period;
transmission of the target channel in the target period and at least one period after the target period; and
transmission of the target channel in at least one period after the target period.

The target period is a period to which a moment at which the indication information is received belongs.

Optionally, the first sending module 502 is specifically configured to send all repetitions of the target channel based on the first information.

Optionally, the first sending module 502 is specifically configured to: send a first repetition of the target channel based on the first information; and send an n^{th} repetition of the target channel based on a target transmission mode, where
n is an integer greater than 1, and the target transmission mode includes:
transmitting the target channel by using a second spatial attribute, where the second spatial attribute is determined based on the first repetition of the target channel.

Optionally, the second spatial attribute meets any one of the following:
the second spatial attribute is the same as a spatial attribute corresponding to the first repetition of the target channel; and
the second spatial attribute is determined based on a spatial attribute pattern associated with the first repetition of the target channel, where the spatial attribute pattern is used to indicate a spatial attribute corresponding to each of a plurality of repetitions of the target channel.

Optionally, the spatial attribute includes at least one of the following:
a number of an uplink transmission resource set;
a number of an uplink transmission resource;
a number of a spatial relationship;
a transmission configuration indication status or quasi co-location;
a quantity of ports or a port number;
a code division multiplexing CDM type or a CDM number; and
density of a resource element.

Referring to FIG. 6, an embodiment of this application further provides an uplink channel transmission apparatus. As shown in FIG. 6, the uplink channel transmission apparatus 600 includes:
a second sending module 601, configured to send at least one channel configuration to a terminal, where the channel configuration is used to indicate at least one target channel, and each target channel corresponds to at least one spatial attribute; and
a second receiving module 602, configured to receive the target channel from the terminal based on first information.

A spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

Optionally, the second receiving module 602 includes:
a second determining unit, configured to determine, based on an association relationship between the first information and the spatial attribute, a first spatial attribute corresponding to first information of a target time domain unit, where the target time domain unit is any time unit for sending the target channel; and
a receiving unit, configured to receive the target channel in the target time domain unit by using the first spatial attribute.

Optionally, the association relationship between the first information and the spatial attribute is specified in a protocol or configured by the apparatus.

Optionally, the receiving unit is specifically configured to perform at least one of the following:
receiving the target channel in the target time domain unit by using a sounding reference signal SRS resource set corresponding to the first spatial attribute or an SRS port associated with an SRS resource set corresponding to the first spatial attribute; and receiving the target channel in the target time domain unit by using a spatial direction of SRS reception corresponding to the first spatial attribute or a spatial direction of channel state information reference signal reception corresponding to the first spatial attribute.

Optionally, the second sending module 601 is further configured to send indication information to the terminal, where the indication information is used to indicate the first information or second information.

The second information includes a spatial attribute associated with an uplink transmission resource, there is an association relationship between the spatial attribute and the first information, and the uplink transmission resource is used to transmit the target channel.

Optionally, the indication information is carried by using group common downlink control information DCI or scheduling DCI.

Optionally, the indication information is used for at least one of the following:
transmission of the target channel in a target period;
transmission of the target channel in a next period of the target period;
transmission of the target channel in the target period and at least one period after the target period; and
transmission of the target channel in at least one period after the target period.

The target period is a period to which a moment at which the indication information is received belongs.

Optionally, the second receiving module 602 is specifically configured to receive all repetitions of the target channel from the terminal based on the first information.

Optionally, the second receiving module 602 is specifically configured to: receive a first repetition of the target channel from the terminal based on the first information; and receive an n^{th} repetition of the target channel from the terminal based on a target transmission mode, where
n is an integer greater than 1, and the target transmission mode includes:
transmitting the target channel by using a second spatial attribute, where the second spatial attribute is determined based on the first repetition of the target channel.

Optionally, the second spatial attribute meets any one of the following:
the second spatial attribute is the same as a spatial attribute corresponding to the first repetition of the target channel; and
the second spatial attribute is determined based on a spatial attribute pattern associated with the first repetition of the target channel, where the spatial attribute pattern is used to indicate a spatial attribute corresponding to each of a plurality of repetitions of the target channel.

Optionally, the spatial attribute includes at least one of the following:
a number of an uplink transmission resource set;
a number of an uplink transmission resource;
a number of a spatial relationship;
a transmission configuration indication status or quasi co-location;
a quantity of ports or a port number;
a code division multiplexing CDM type or a CDM number; and
density of a resource element.

The uplink channel transmission apparatus in this embodiment of this application may be an electronic device, for example, an electronic device with an operating system, or may be a component such as an integrated circuit or a chip in the electronic device. The electronic device may be a terminal, or may be another device different from a terminal. For example, the terminal may include but is not limited to the foregoing listed types of the terminal 11. The another device may be a server, a Network Attached Storage (NAS), or the like. This is not specifically limited in this embodiment of this application.

The uplink channel transmission apparatus provided in this embodiment of this application can implement the processes implemented in the method embodiments of FIG. 2 to FIG. 4, and achieve the same technical effects. To avoid repetition, details are not described herein again.

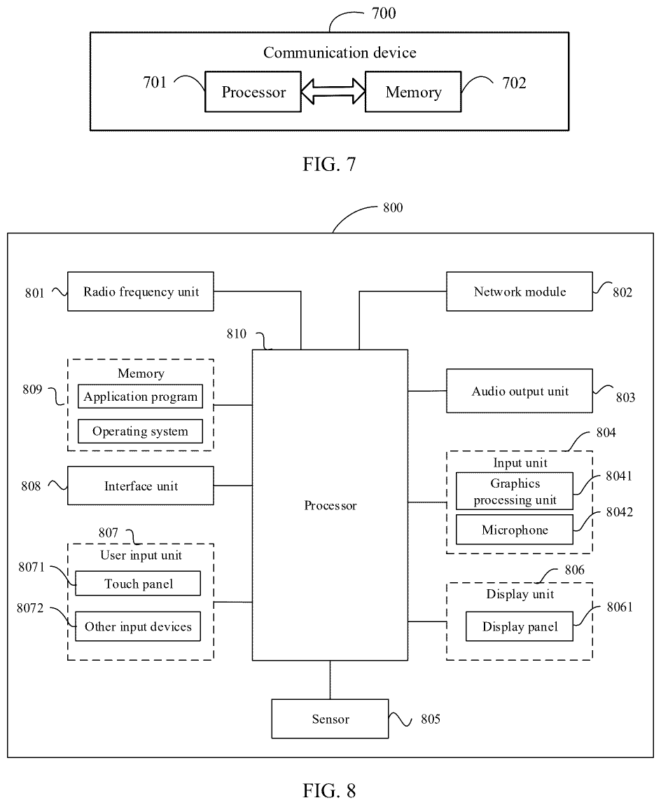

Optionally, as shown in FIG. 7, an embodiment of this application further provides a communication device 700, including a processor 701 and a memory 702. The memory 702 stores a program or instructions capable of running on the processor 701. The program or the instructions are executed by the processor 701 to implement the steps of the foregoing uplink channel transmission method embodiments, and can achieve the same technical effects. To avoid repetition, details are not described herein again.

An embodiment of this application further provides a terminal, including a processor and a communication interface. The communication interface is configured to: receive at least one channel configuration from a network-side device, where the channel configuration is used to indicate at least one target channel, and each target channel corresponds to at least one spatial attribute; and send the target channel based on first information, where a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information. This terminal embodiment corresponds to the foregoing terminal-side method embodiments. Each implementing process and implementation of the foregoing method embodiments are applicable to this terminal embodiment, and the same technical effects can be achieved. Specifically, FIG. 8 is a schematic structural diagram of hardware of a terminal for implementing an embodiment of this application.

The terminal 800 includes but is not limited to at least some components of a radio frequency unit 801, a network module 802, an audio output unit 803, an input unit 804, a sensor 805, a display unit 806, a user input unit 807, an interface unit 808, a memory 809, a processor 810, and the like.

A person skilled in the art may understand that the terminal 800 may further include a power supply (for example, a battery) that supplies power to each component. The power supply may be logically connected to the processor 810 by using a power management system, so as to implement functions such as charging management, discharging management, and power consumption management by using the power management system. The structure of the terminal shown in FIG. 8 does not constitute a limitation on the terminal. The terminal may include more or fewer components than those shown in the figure, or combine some components, or have different component arrangements. Details are not described herein again.

It should be understood that in this embodiment of this application, the input unit 804 may include a Graphics Processing Unit (GPU) 8041 and a microphone 8042. The graphics processing unit 8041 processes image data of a still picture or a video obtained by an image capture apparatus (such as a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and other input devices 8072. The touch panel 8071 is also referred to as a touchscreen. The touch panel 8071 may include two parts: a touch detection apparatus and a touch controller. The other input devices 8072 may include but are not limited to a physical keyboard, a function key (such as a volume control key or an on/off key), a trackball, a mouse, and a joystick. Details are not described herein.

In this embodiment of this application, after receiving downlink data from a network-side device, the radio frequency unit 801 may transmit the downlink data to the processor 810 for processing. In addition, the radio frequency unit 801 may send uplink data to the network-side device. Generally, the radio frequency unit 801 includes but is not limited to an antenna, an amplifier, a transceiver, a coupler, a low-noise amplifier, a duplexer, and the like.

The memory 809 may be configured to store a software program or instructions and various types of data. The memory 809 may mainly include a first storage area for storing a program or instructions and a second storage area for storing data. The first storage area may store an operating system, an application program or instructions required by at least one function (for example, a sound play function or an image play function), and the like. In addition, the memory 809 may include a volatile memory or a non-volatile memory, or the memory 809 may include both a volatile memory and a non-volatile memory. The non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 809 in this embodiment of this application includes but is not limited to these memories and any other suitable type of memory.

The processor 810 may include one or more processing units. Optionally, the processor 810 integrates an application processor and a modem processor. The application processor mainly processes operations related to an operating system, a user interface, an application program, and the like. The modem processor mainly processes a wireless communication signal, such as a baseband processor. It may be understood that the modem processor may not be integrated into the processor 810.

The radio frequency unit 801 is configured to: receive at least one channel configuration from a network-side device, where the channel configuration is used to indicate at least one target channel, and each target channel corresponds to at least one spatial attribute; and send the target channel based on first information, where a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information.

An embodiment of this application further provides a network-side device, including a processor and a communication interface. The communication interface is configured to: send at least one channel configuration to a terminal, where the channel configuration is used to indicate at least one target channel, and each target channel corresponds to at least one spatial attribute; and receive the target channel from the terminal based on first information, where a spatial attribute used to send the target channel is determined based on the first information, the target channel includes a configured grant physical uplink shared channel PUSCH or a configured grant physical uplink control channel PUCCH, and the first information includes at least one of the following: a slot format, a slot type, and subband full duplex configuration information or subband full duplex indication information. This network-side device embodiment corresponds to the foregoing network-side device method embodiments. Each implementing process and implementation of the foregoing method embodiments are applicable to this network-side device embodiment, and the same technical effects can be achieved.

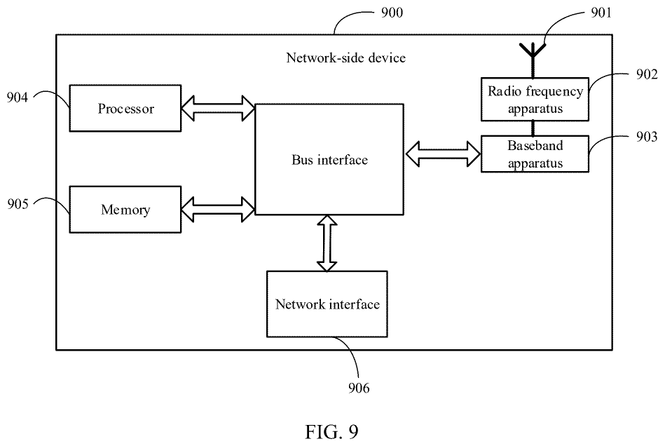

Specifically, an embodiment of this application further provides a network-side device. As shown in FIG. 9, the network-side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information, and sends processed information to the radio frequency apparatus 902. After processing the received information, the radio frequency apparatus 902 sends processed information through the antenna 901.

The method performed by the network-side device in the foregoing embodiment may be implemented in the baseband apparatus 903. The baseband apparatus 903 includes a baseband processor.

For example, the baseband apparatus 903 may include at least one baseband board. A plurality of chips are disposed on the baseband board. As shown in FIG. 9, one of the chips is, for example, the baseband processor, and is connected to the memory 905 by using a bus interface, to invoke a program in the memory 905 to perform an operation of the network-side device shown in the foregoing method embodiment.

The network-side device may further include a network interface 906. For example, the interface is a common public radio interface (CPRI).

Specifically, the network-side device 900 in this embodiment of the present invention further includes instructions or a program that is stored in the memory 905 and that is capable of running on the processor 904. The processor 904 invokes the instructions or the program in the memory 905 to perform the method performed by the modules shown in FIG. 6, and the same technical effects are achieved. To avoid repetition, details are not described herein again.

An embodiment of this application further provides a readable storage medium. The readable storage medium stores a program or instructions. The program or the instructions are executed by a processor to implement the processes in the foregoing uplink channel transmission method embodiments, and the same technical effects can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing uplink channel transmission method embodiments, and the same technical effects can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing uplink channel transmission method embodiments, and the same technical effects can be achieved. To avoid repetition, details are not described herein again.

An embodiment of this application further provides a communication system. The communication system includes a terminal and a network-side device. The terminal is configured to perform the processes in FIG. 2 and the foregoing terminal-side method embodiments. The network-side device is configured to perform the processes in FIG. 4 and the foregoing network-side device method embodiments. The same technical effects can be achieved. To avoid repetition, details are not described herein again.

It should be noted that in this specification, the term “comprise”, “include”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings. However, this application is not limited to the foregoing specific implementations. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

1. An uplink channel transmission method, comprising:
receiving, by a terminal, at least one channel configuration from a network-side device, wherein the channel configuration is used to indicate at least one target channel, and each target channel corresponds to at least one spatial attribute; and
sending, by the terminal, the target channel based on first information, wherein
a spatial attribute used to send the target channel is determined based on the first information, the target channel comprises a configured grant physical uplink shared channel (PUSCH) or a configured grant physical uplink control channel (PUCCH), and the first information comprises at least one of the following: a slot format, a slot type, and subband full duplex configuration information or subband full duplex indication information.

2. The method according to claim 1, wherein the sending, by the terminal, the target channel based on first information comprises:
determining, by the terminal based on an association relationship between the first information and the spatial attribute, a first spatial attribute corresponding to first information of a target time domain unit, wherein the target time domain unit is any time unit for sending the target channel; and
sending, by the terminal, the target channel in the target time domain unit by using the first spatial attribute.

3. The method according to claim 2, wherein the association relationship between the first information and the spatial attribute is specified in a protocol or configured by the network-side device.

4. The method according to claim 2, wherein the sending, by the terminal, the target channel in the target time domain unit by using the first spatial attribute comprises at least one of the following:
sending, by the terminal, the target channel in the target time domain unit by using a sounding reference signal (SRS) resource set corresponding to the first spatial attribute or an SRS port associated with an SRS resource set corresponding to the first spatial attribute; and
sending, by the terminal, the target channel in the target time domain unit by using a spatial direction of SRS reception corresponding to the first spatial attribute or a spatial direction of channel state information reference signal reception corresponding to the first spatial attribute.

5. The method according to claim 1, wherein before the sending, by the terminal, the target channel based on first information, the method further comprises:
receiving, by the terminal, indication information from the network-side device, wherein the indication information is used to indicate the first information or second information, wherein
the second information comprises a spatial attribute associated with an uplink transmission resource, there is an association relationship between the spatial attribute and the first information, and the uplink transmission resource is used to transmit the target channel.

6. The method according to claim 5, wherein the indication information is carried by using group common downlink control information (DCI) or scheduling DCI, and/or
wherein the indication information is used for at least one of the following:
transmission of the target channel in a target period;
transmission of the target channel in a next period of the target period;
transmission of the target channel in the target period and at least one period after the target period; and
transmission of the target channel in at least one period after the target period, wherein
the target period is a period to which a moment at which the indication information is received belongs.

7. The method according to claim 1, wherein the sending, by the terminal, the target channel based on first information comprises:
sending, by the terminal, all repetitions of the target channel based on the first information; or
sending, by the terminal, a first repetition of the target channel based on the first information; and sending, by the terminal, an n^{th} repetition of the target channel based on a target transmission mode, wherein n is an integer greater than 1, and the target transmission mode comprises: transmitting the target channel by using a second spatial attribute, wherein the second spatial attribute is determined based on the first repetition of the target channel.

8. The method according to claim 7, wherein the second spatial attribute meets any one of the following:
the second spatial attribute is the same as a spatial attribute corresponding to the first repetition of the target channel; and
the second spatial attribute is determined based on a spatial attribute pattern associated with the first repetition of the target channel, wherein the spatial attribute pattern is used to indicate a spatial attribute corresponding to each of a plurality of repetitions of the target channel.

9. The method according to claim 1, wherein the spatial attribute comprises at least one of the following:
a number of an uplink transmission resource set;
a number of an uplink transmission resource;
a number of a spatial relationship;
a transmission configuration indication status or quasi co-location;
a quantity of ports or a port number;
a code division multiplexing (CDM) type or a CDM number; and
density of a resource element.

10. An uplink channel transmission method, comprising:
sending, by a network-side device, at least one channel configuration to a terminal, wherein the channel configuration is used to indicate at least one target channel, and each target channel corresponds to at least one spatial attribute; and
receiving, by the network-side device, the target channel from the terminal based on first information, wherein
a spatial attribute used to send the target channel is determined based on the first information, the target channel comprises a configured grant physical uplink shared channel (PUSCH) or a configured grant physical uplink control channel (PUCCH), and the first information comprises at least one of the following: a slot format, a slot type, and subband full duplex configuration information or subband full duplex indication information.

11. The method according to claim 10, wherein the receiving, by the network-side device, the target channel from the terminal based on first information comprises:
determining, by the network-side device based on an association relationship between the first information and the spatial attribute, a first spatial attribute corresponding to first information of a target time domain unit, wherein the target time domain unit is any time unit for sending the target channel; and
receiving, by the network-side device, the target channel in the target time domain unit by using the first spatial attribute.

12. The method according to claim 11, wherein the association relationship between the first information and the spatial attribute is specified in a protocol or configured by the network-side device.

13. The method according to claim 12, wherein the receiving, by the network-side device, the target channel in the target time domain unit by using the first spatial attribute comprises at least one of the following:
receiving, by the network-side device, the target channel in the target time domain unit by using a sounding reference signal (SRS) resource set corresponding to the first spatial attribute or an SRS port associated with an SRS resource set corresponding to the first spatial attribute; and
receiving, by the network-side device, the target channel in the target time domain unit by using a spatial direction of SRS reception corresponding to the first spatial attribute or a spatial direction of channel state information reference signal reception corresponding to the first spatial attribute.

14. The method according to claim 10, wherein before the sending, by a network-side device, at least one channel configuration to a terminal, the method further comprises:
sending, by the network-side device, indication information to the terminal, wherein the indication information is used to indicate the first information or second information, wherein
the second information comprises a spatial attribute associated with an uplink transmission resource, there is an association relationship between the spatial attribute and the first information, and the uplink transmission resource is used to transmit the target channel.

15. The method according to claim 14, wherein the indication information is carried by using group common downlink control information (DCI) or scheduling DCI, and/or
wherein the indication information is used for at least one of the following:
transmission of the target channel in a target period;
transmission of the target channel in a next period of the target period;
transmission of the target channel in the target period and at least one period after the target period; and
transmission of the target channel in at least one period after the target period, wherein
the target period is a period to which a moment at which the indication information is received belongs.

16. The method according to claim 10, wherein the receiving, by the network-side device, the target channel from the terminal based on first information comprises:
receiving, by the network-side device, all repetitions of the target channel from the terminal based on the first information; or
receiving, by the network-side device, a first repetition of the target channel from the terminal based on the first information; and receiving, by the terminal, an n^{th} repetition of the target channel from the terminal based on a target transmission mode, wherein n is an integer greater than 1, and the target transmission mode comprises: transmitting the target channel by using a second spatial attribute, wherein the second spatial attribute is determined based on the first repetition of the target channel.

17. The method according to claim 16, wherein the second spatial attribute meets any one of the following:
the second spatial attribute is the same as a spatial attribute corresponding to the first repetition of the target channel; and
the second spatial attribute is determined based on a spatial attribute pattern associated with the first repetition of the target channel, wherein the spatial attribute pattern is used to indicate a spatial attribute corresponding to each of a plurality of repetitions of the target channel.

18. The method according to claim 10, wherein the spatial attribute comprises at least one of the following:
a number of an uplink transmission resource set;
a number of an uplink transmission resource;
a number of a spatial relationship;
a transmission configuration indication status or quasi co-location;
a quantity of ports or a port number;
a code division multiplexing (CDM) type or a CDM number; and
density of a resource element.

19. A terminal, comprising at least one hardware processor and a memory, wherein the memory stores a program or instructions executable by the at least one hardware processor that, when executed, direct the at least one hardware processor to implement the uplink channel transmission method according to claim 1.

20. A network-side device, comprising at least one hardware processor and a memory, wherein the memory stores a program or instructions executable by the at least one hardware processor that, when executed, direct the at least one hardware processor to implement the uplink channel transmission method according to claim 10.
